(19) United States
(12) Patent Application Publication
(10) Pub. No.: US 2026/0309641 A1
(43) Pub. Date: Oct. 8, 2026

(54) INSPECTION DEVICE AND INSPECTION METHOD

(71) Applicant: HITACHI INDUSTRY & CONTROL SOLUTIONS, LTD., Tokyo (JP)

(72) Inventors: Tadahiro KATANE, Tokyo (JP); Atsufumi SODEYAMA, Tokyo (JP); Nozomu KIRIU, Tokyo (JP); Kazuki TSUSHIMA, Tokyo (JP); Isao SHINADA, Tokyo (JP); Takahiro KUSAKA, Tokyo (JP)

(73) Assignee: HITACHI INDUSTRY & CONTROL SOLUTIONS, LTD., Tokyo (JP)

(21) Appl. No.: 18/996,630

(22) PCT Filed: Jun. 15, 2023
(86) PCT No.: PCT/JP2023/022225

§ 371 Date: Jan. 17, 2025

(30) Foreign Application Priority Data
Sep. 13, 2022 (JP) 2022-145315

(51) Int. Cl. G01N 21/90; G01N 21/88; G06V 10/25; G06V 20/70

(52) U.S. Cl. CPC G01N 21/9027; G01N 21/8851; G06V 10/25; G06V 20/70

(57) ABSTRACT

The present invention improves the accuracy of visual inspection. An inspection device comprises: an image processing unit for performing image processing on a video image captured of an inspected object; an Al processing unit for labeling a foreign object captured in a video image of an inspected object on the basis of a learning parameter that has been obtained by learning training data which is a combination of a video image captured of an inspected object and an indicator indicative of whether the inspected object is a non-defective item or a defective item; and a determination unit for determining whether an inspected object is a non-defective item or a defective item on the basis of the video image that has been processed by the image processing unit and a video image that has been labeled by the Al processing unit.

### TECHNICAL FIELD

The present invention relates to an inspection device and an inspection method.

### BACKGROUND ART

Conventionally, in the case of inspecting a foreign matter in a liquid put in a transparent container, a foreign matter inspection device as shown in Patent Literature 1 has been used. In this foreign matter inspection device, such foreign matter inspection is conducted in which after the transparent container is rotated and stopped, a foreign matter floating in the liquid inertially rotating in the transparent container is detected by using a camera, a sensor, or the like.

In addition, appearance inspection is also conducted in which the state of appearance of this liquid-filled container is inspected.

### CITATION LIST

### Patent Literature

Patent Literature 1: JP2014-109526A

### SUMMARY OF INVENTION

### Technical Problem

A conventional inspection device inspects whether or not there is a foreign matter by rotating and then stopping a liquid-filled container, capturing a video image of a contained liquid in the state where only the contained liquid is moving, and inspecting whether or not there is something moving inside. However, there is a problem that in the case where there is a bubble inside, it is difficult to distinguish the bubble and a foreign matter, frequently causing erroneous detections.

In addition, in the appearance inspection on a liquid-filled container, it is difficult to inspect a rubber plug portion of a vial having a complicated shape, a portion near a shoulder portion of a vial where a water droplet is attached, a portion near a liquid surface, and the like because there are many variations due to influences of the product and environment. Such portions have been visually inspected by humans. Hence, there is a demand for conducting an appearance inspection with a machine with a sufficient accuracy even in such cases.

In view of this, an object of the present invention is to improve accuracy of a foreign matter inspection in a liquid and an appearance inspection.

### Solution to Problem

To solve the above-described problems, an inspection device of the present invention comprises: an image processor which conducts image processing on a video image captured of an inspection target object; an AI processor which labels a foreign matter captured in the video image of the inspection target object based on a learning parameter obtained by learning teaching data in which a video image of the inspection target object and an indicator indicating whether the inspection target object is a non-defective item or a defective item are combined; and a determination unit which determines whether the inspection target object is a non-defective item or a defective item based on a video image processed by the image processor and a video image labeled by the AI processor.

An inspection method of the present invention comprises the steps of: conducting image processing on a video image captured of an inspection target object, by an image processor; labeling a foreign matter captured in the video image of the inspection target object based on a learning parameter obtained by learning teaching data in which a video image of the inspection target object and an indicator indicating whether the inspection target object is a non-defective item or a defective item, by an AI processor; and determining whether the inspection target object is a non-defective item or a defective item based on a video image processed by the image processor and a video image labeled by the AI processor, by a determination unit.

The other solutions will be described in DESCRIPTION OF EMBODIMENTS.

### Advantageous Effects of Invention

The present invention makes it possible to improve accuracy of appearance inspection. In addition, the present invention makes it possible to reduce blind spots in appearance inspection on a container and to reduce portions to be visually inspected.

### BRIEF DESCRIPTION OF DRAWINGS

FIG. 1 is a configuration diagram of an inspection device according to the present embodiment.

FIG. 2 is a conceptual diagram showing a seat and an illumination of the inspection device.

FIG. 3 is a diagram for explaining an operation at the time of production video recording of the inspection device.

FIG. 4 is a diagram for explaining an operation at the time of reproduction adjustment of the inspection device.

FIG. 5 is a configuration diagram of a learning environment device.

FIG. 6 is a diagram for explaining a learning procedure of an AI processing unit.

FIG. 7 is a flowchart of learning processing of the AI processing unit.

FIG. 8 is a flowchart of inspection processing.

FIG. 9 is an input video image relating to a black foreign matter.

FIG. 10 is an image obtained by segmenting the input video image relating to the black foreign matter to recognize a defective portion.

FIG. 11 is an input video image relating to a white foreign matter.

FIG. 12 is an image obtained by segmenting the input video image relating to the white foreign matter to recognize a defective portion.

FIG. 13 is an input video image relating to a bubble.

FIG. 14 is an image obtained by segmenting the input video image relating to the bubble.

### DESCRIPTION OF EMBODIMENTS

Hereinafter, modes for carrying out the present invention will be described in detail with reference to each drawing.

The first case to be subjected to the present invention is a case in which there is a variation in non-defective state, and includes a foreign matter inspection on upper surfaces of freeze-dried formulations (cakes) and the like. Since there is a larger variation (cake cracks and the like) in non-defective shape than in defects, it is difficult to distinguish non-defective shapes from defects. The current issue is erroneously detecting cake cracks as defects.

The second case is a case in which an inspection region or a detection sensitivity is restricted, and includes a foreign matter inspection on lateral sides of rubber plugs of syringes and the like. In the case where there is a defect in a shape-changing portion (a boundary portion or the like), an inspection region or a detection sensitivity is restricted. The current issue is missing defects and detecting boundary portions as defects.

The third case is a case in which an image at the time of inspection changes every time, and includes a foreign matter inspection on insides of rubber plugs of vials. Since inspection images are captured through rotation, it is necessary to set inspection regions depending on the angle. The current issue is missing defects and detecting boundary portions as defects.

Hereinafter, the present embodiment relates to a foreign matter inspection device, and will be described by giving techniques of foreign matter inspection in liquids put in transparent containers such as ampoules or vials and appearance inspection on a liquid-filled container as examples. However, the present invention is not limited to this and may be applied to the above-described first to third cases, without limitation.

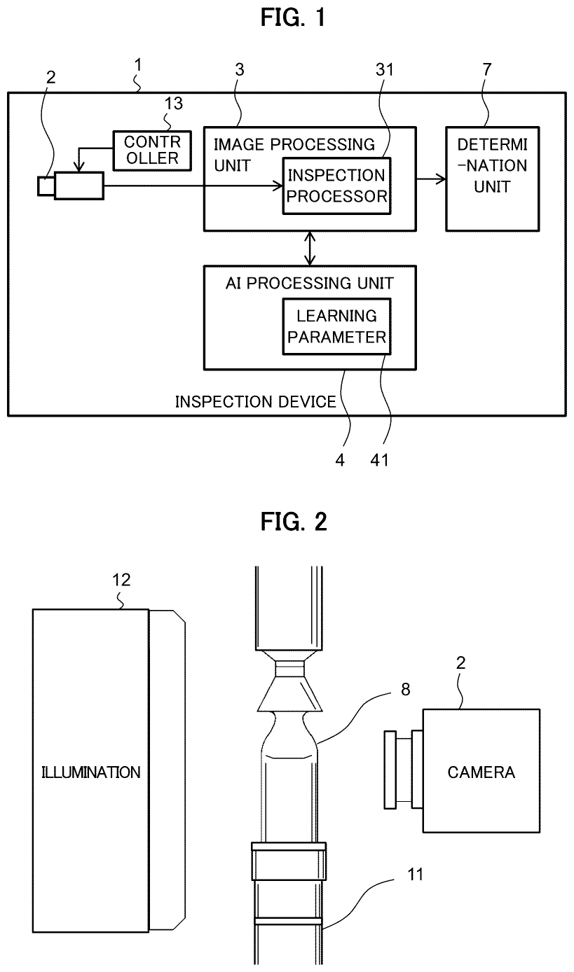

FIG. 1 is a configuration diagram of an inspection device 1 according to the present embodiment.

The inspection device 1 is configured to inspect a foreign matter in an inspection object in an inspection target container 8 shown in FIG. 2 and an appearance of the inspection target container 8. The inspection device 1 includes a camera 2, a controller 13, an image processing unit 3, an AI processing unit 4, and a determination unit 7.

As shown in FIG. 2, this inspection device 1 includes a seat 11 for rotating the inspection target container 8 and an illumination 12 for emitting light to the inspection target container 8 from side.

The camera 2 captures an image of the inspection target container 8. Note that the camera 2 only has to capture an image of an inspection target object. The inspection target object is not limited to the inspection target container 8 and a liquid in the inspection target container 8. The controller 13 aligns the conditions of a video image captured of the inspection target object through luminance correction and inspection position correction of the camera 2.

As shown in FIG. 1, the image processing unit 3 is an image processor which includes an inspection processor 31 for conducting filter processing on an inputted video image signal and conducts image processing on a video image of the inspection target container 8 captured by the camera 2. This makes it possible for the determination unit 7 to determine whether or not there is a foreign matter in the liquid. The AI processing unit 4 is an AI processor which stores a learning parameter 41 obtained by learning foreign matters and executes AI (Artificial Intelligence) processing of segmentation on a video image taken by the camera 2. The AI processing unit 4 stores the learning parameter 41 obtained by learning teaching data combining a video image of the inspection target container 8 captured by the camera 2 and an indicator indicating whether the inspection target container 8 is a non-defective item or a defective item. The AI processing unit 4 labels a foreign matter captured in a video image of the inspection target container 8 by using the learning parameter 41. Here, labeling a foreign matter means that the AI processing unit 4 attaches label information which indicates a foreign matter to a video image region in which this foreign matter has been captured.

The determination unit 7 inspects whether or not there is a foreign matter based on a video image processed by the image processing unit 3 and a video image labeled by the AI processing unit 4, and further inspects whether or not there is an appearance defect. The determination unit 7 is capable of determining whether or not there is a foreign matter for each pixel by using a video image subjected to the AI processing.

The determination unit 7 extracts a first abnormal region from the video image processed by the image processing unit 3, and extracts a second abnormal region from the video image labeled by the AI processing unit 4. The determination unit 7 determines whether each of the inspection target container 8 and the liquid in the inspection target container 8 is a non-defective item or a defective item through a logical conjunction between the first abnormal region and the second abnormal region.

The inspection device 1 conducts AI processing by the AI processing unit 4 at the same time as the conventional inspection by the image processing unit 3. Then, the determination unit 7 combines a result of the AI processing and a result of the conventional inspection and makes comprehensive determination from both determinations on defectiveness (logical conjunction). This makes it possible to improve accuracy of the appearance inspection by the machine. In addition, this makes it possible to reduce blind spots in the appearance inspection on a container and to reduce portions to be visually inspected. In addition, since comprehensive determination is made from both determinations on defectiveness (logical conjunction), it is allowed to erroneously determine non-defective items as defects by the AI processing to some extent. Therefore, the learning man-hour can be reduced.

Note that the determination unit 7 may combine the result of the AI processing and the result of the conventional inspection and make comprehensive determination from one of the determinations on defectiveness (logical disjunction). In this case, since it is allowed to erroneously determine non-defective items as defects to some extent, the learning man-hour can be reduced.

In addition, although learning is necessary to conduct AI processing, there is a problem that reproduction is difficult in learning on the inspection device 1 and that learning for adjusting parameters cannot be conducted in parallel during production.

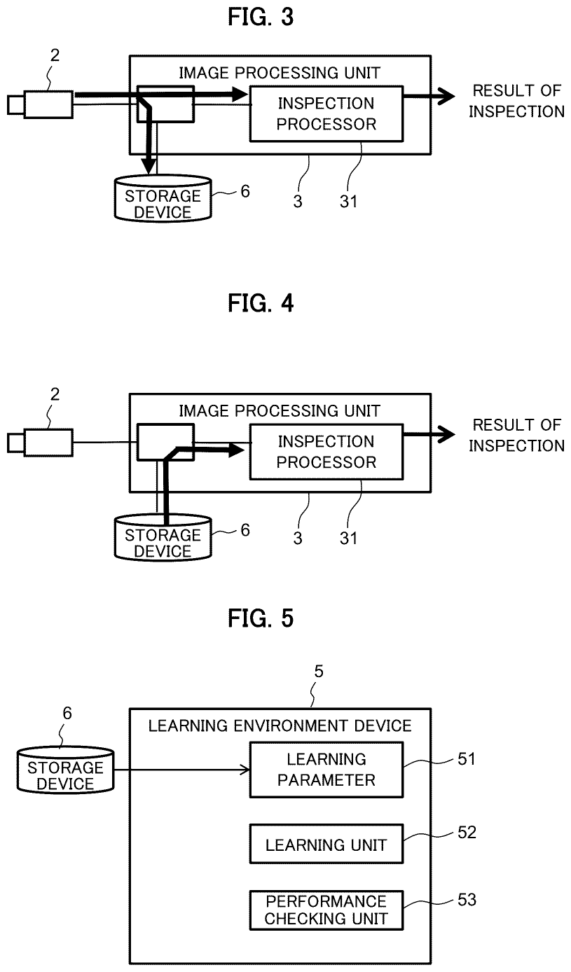

As shown in FIG. 3, the image processing unit 3 digitally records, in the storage device 6, a captured video image of the inspection target container 8 during production, which is captured by the camera 2, by using a video recording function of the inspection device 1 shown in FIG. 1. This makes it possible to record all input video images to obtain a large amount of data for AI learning while evaluating video images and operating the production.

As shown in FIG. 4, a result of the inspection is outputted by reproducing the video images recorded in the storage device 6 without machine operation, and evaluating and adjusting these by the image processing unit 3. By manually correcting this result of the inspection, teaching data can be obtained.

As shown in FIG. 5, a learning environment device 5, which is separate from the inspection device 1, generates a learning parameter 51 by causing a learning unit 52 to learn by using these captured video images and teaching data. The performance checking unit 53 checks the inspection performance by the learning parameter 51.

The performance checking unit 53 conducts simulation of the learning parameter 51, which is a result of the learning, in both of the conventional processing and the AI processing, by using the captured video images recorded in the storage device 6. Hence, it becomes possible to check the effect by comparing the results.

Once the effect is checked, the learning environment device 5 registers, the learning parameter 51, which is a result of the learning of the AI processing, to the inspection device 1 as the learning parameter 41. In this way, this result of the learning is reflected in the inspection device 1.

In the AI processing, a human needs to designate backgrounds, foreign matters, scratches, bubbles, or the like for learning. To reduce the man-hour, the present embodiment extracts information such as backgrounds, foreign matters, smears, or the like by using a function of the conventional image processing unit 3 and displays an extraction result on a screen. Based on the display on the screen, a human checks whether or not there is a mistake in the determination of the image processing unit 3. This makes it possible to relatively easily generate teaching data.

Then, the learning environment device 5 learns this teaching data. In addition, at this time, in order to reduce decision by a human, the learning environment device 5 can reduce the number of items to be determined by using conditions that the learning environment device 5 ignores a foreign matter of a certain size or smaller, determines a thin item as a non-defective item, or the like.

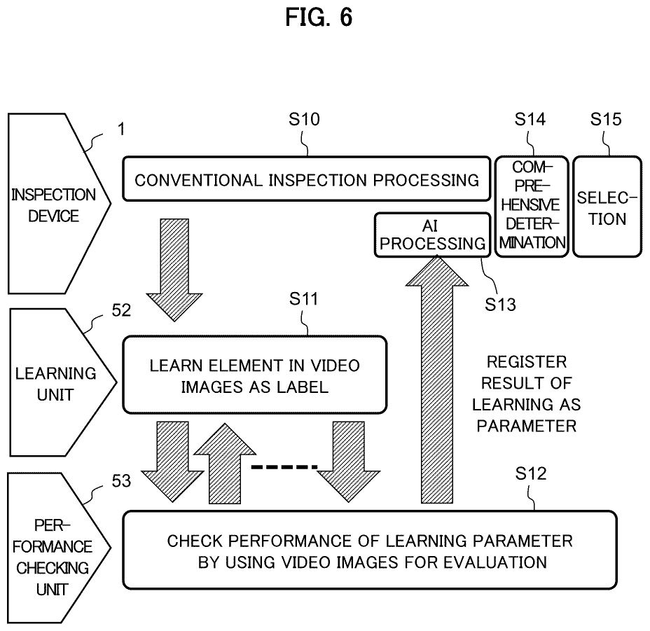

FIG. 6 is a diagram for explaining a learning procedure of the AI processing unit 4 shown in FIG. 1.

This learning procedure is broadly divided into processing by the inspection device 1, processing by the learning unit 52, and processing by the performance checking unit 53.

In step S10, the inspection device 1 executes conventional inspection processing. A result of this conventional inspection processing and captured video images are passed to the learning unit 52.

In step S11, the learning unit 52 learns an element in the video images as a label based on the result of the conventional inspection processing and the captured video images at this time. The learning parameter 51 (FIG. 5), which is a result of this learning, is passed to the performance checking unit 53.

In step S12, the performance checking unit 53 checks the performance of the learning parameter 51 (FIG. 5) by using video images for evaluation. The processing of steps S11 and S12 is repeated until a desired performance is obtained. Here, the desired performance means that the AI processing using the learning parameter 51 determines, as a non-defective item, a bubble or the like that is erroneously determined as a defect by the image processing unit 3, and also the AI processing determines, as a defect, a foreign matter or a scratch that is correctly determined as a defect by the image processing unit 3. The AI processing using the learning parameter 51 may erroneously determine an actually non-defective item as a defect. Such erroneous determination can be corrected by the logical disjunction of the determination unit 7, and is thus non-problematic. This makes it possible to reduce the learning man-hour by the learning unit 52 and the number of teaching data to be learned by this learning unit 52.

Once the result of the learning of the desired performance is obtained, the learning environment device 5 registers the learning parameter 51, which is the result of the learning, to the inspection device 1.

In step S13, the inspection device 1 executes the conventional inspection processing and the AI processing in parallel. Then, in step S14, the determination unit 7 makes comprehensive determination by evaluating a result of the conventional inspection processing and a result of the AI processing. In step S15, once the determination unit 7 selects a normal inspection target object, the series of learning processing is completed.

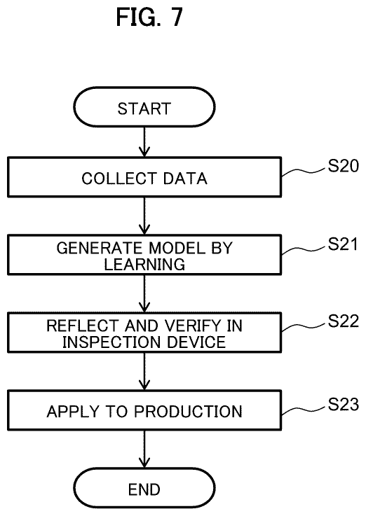

FIG. 7 is a flowchart of the learning processing of the AI processing unit 4. This flowchart is obtained by rewriting the learning procedure of the FIG. 6.

First, the inspection device 1 collects data by using the video recording function of the storage device 6 (step S20). Then, the learning environment device 5 generates a model by learning (step S21). Here, the model is configured with the learning parameter 51.

Next, the operator reflects and verifies the learning parameter 51, which is the model, in the inspection device 1 (step S22), then applies the learning parameter 51 to actual production (step S23), and ends the processing of FIG. 7.

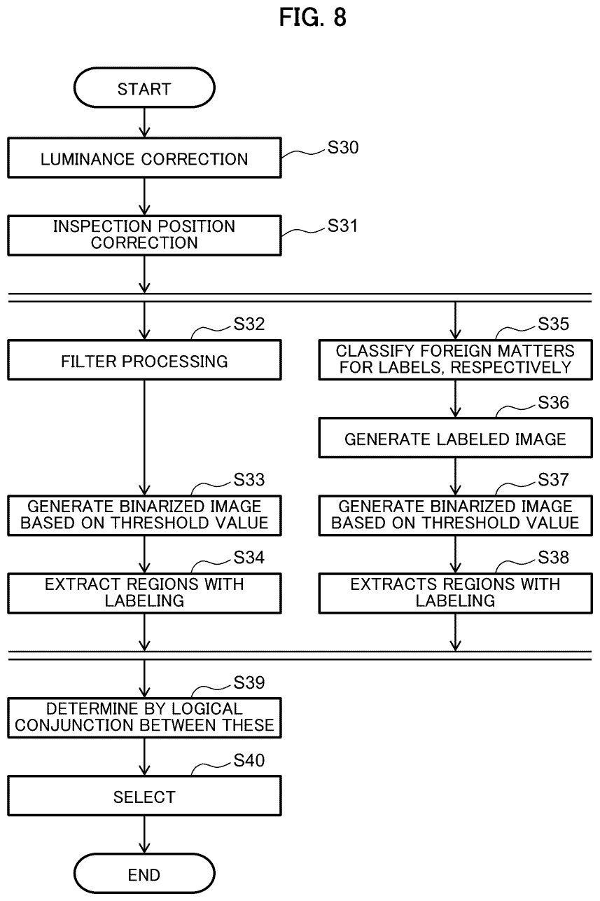

FIG. 8 is a flowchart of the inspection processing. The inspection processing will be described with reference to FIG. 1 as appropriate.

First, the controller 13 conducts luminance correction of the camera 2 (step S30), and conducts inspection position correction (step S31), to align conditions of a video image captured of an inspection target object. Here, the inspection target object is the inspection target container 8 shown in FIG. 2 and a liquid in the inspection target container 8. This video image is sent to the image processing unit 3, and is also sent to the AI processing unit 4 shown in FIG. 1. Hereinafter, the processing from steps S32 to S34 and the processing from steps S35 to S38 are executed in parallel.

The image processing unit 3 shown in FIG. 1 executes the processing from steps S32 to S34. The image processing unit 3 applies filter processing to the video image by using the inspection processor 31 (step S32). Then, the image processing unit 3 generates a binarized image based on a concentration threshold value (step S33), and extracts regions with labeling (step S34).

The AI processing unit 4 shown in FIG. 1 executes the processing from steps S35 to S38. The AI processing unit 4 classifies foreign matters for labels, respectively, based on the learning parameter 51 (step S35). Then, the AI processing unit 4 generates a video image to which the same color or luminance is applied for each label (step S36).

Then, the AI processing unit 4 generates a binarized image based on a concentration threshold value (step S37), and extracts regions with labeling (step S38).

In step S39, the determination unit 7 executes determination through logical conjunction between a result of the processing of the image processing unit 3 and a result of the processing of the AI processing unit 4. Here, the determination unit 7 extracts a first abnormal region from the video image processed by the image processing unit 3 and a second abnormal region from the video image labeled by the AI processing unit 4. Then, the determination unit 7 determines whether the inspection target object is a non-defective item or a defective item, through logical conjunction between the first abnormal region and the second abnormal region.

Then, once the determination unit 7 selects an inspection target object (step S40), the processing of FIG. 8 is ended.

The advantage of the present embodiment is that the present embodiment can be added as one option for extracting a feature in the conventional processing. By adding the AI processing to the conventional processing, and executing both processing in parallel, it becomes possible to conduct comprehensive determination in combination with a result of the conventional processing.

In order to improve inspection accuracy, the operator of this inspection device 1 combines the conventional image processing and the AI processing and repeats comparison and evaluation.

For example, the flowchart of FIG. 8 is to determine erroneous detection of a foreign matter or the like from a detected defect. At this time, the determination unit 7 reflects a result of the AI processing in determination on defectiveness by using logical conjunction between the first abnormal region and the second abnormal region.

In addition, there is a case where it is desirable to add new AI processing to an uninspected area. In such a case, the determination unit 7 reflects a result of the AI processing in determination on defectiveness by using logical disjunction between the first abnormal region and the second abnormal region.

Note that the configuration is not limited to this, and the determination unit 7 may determine whether an inspection target object is a non-defective item or a defective item by using a result of synthesizing one having a first predetermined size among the first abnormal regions and one having a second predetermined size among the second abnormal regions, without limitation.

An abnormal region that can be favorably detected by the image processing unit 3 is an abnormal region having a size larger than a predetermined value. In contrast, the AI processing is capable of favorably detecting even an abnormal region having a smaller size. Hence, the determination unit 7 is capable of favorably determining whether or not there is an abnormality by selecting results of detection of both depending on the size of the abnormal region and synthesizing both. In this case, since learning of the AI processing can be stopped when it becomes possible to favorably detect an abnormal region having a smaller size, the learning can be completed in a short period of time.

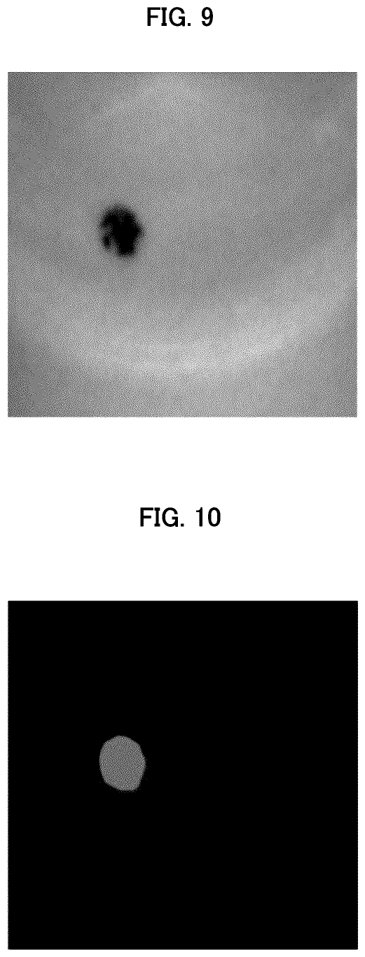

FIG. 9 is an input video image relating to a black foreign matter. The black region is captured on the left side relative to the center of the video image. This black region is an abnormal region.

FIG. 10 is an image obtained by segmenting the input video image relating to the black foreign matter shown in FIG. 9 to recognize a defective portion.

A region having a color different from the other region is shown on the left side relative to the center of the video image. This corresponds to the defective portion.

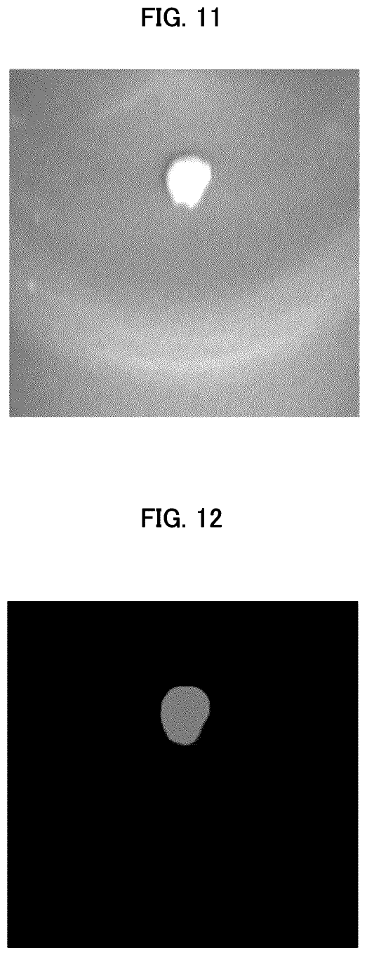

FIG. 11 is an input video image relating to a white foreign matter. The white region is captured on a slightly upper side relative to the center of the video image.

FIG. 12 is an image obtained by segmenting the input video image relating to the white foreign matter shown in FIG. 11 to recognize a defective portion.

A region having a color different from the other region is shown on a slightly upper side relative to the center of the video image. This corresponds to the defective portion.

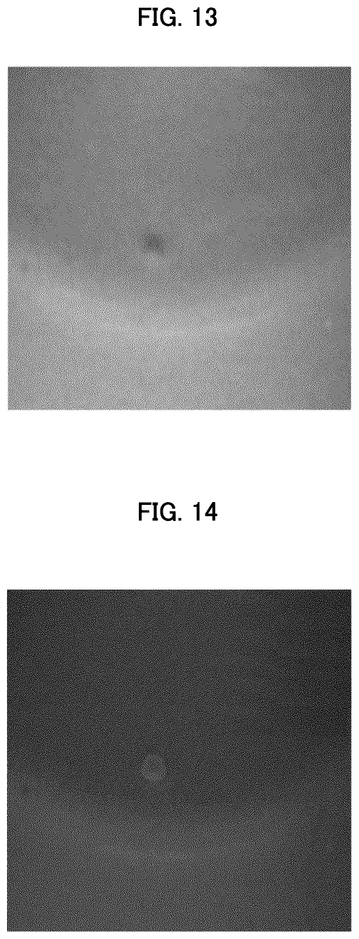

FIG. 13 is an input video image relating to a bubble. A shade of the bubble is shown on the lower left side relative to the center of the video image. This corresponds to a non-defective portion.

FIG. 14 is an image obtained by segmenting the input video image relating to the bubble shown in FIG. 13.

In the video image, there is no region having a color different from the other region. Hence, this bubble corresponds to a non defective portion.

Hereinafter, Application Examples of the present embodiment will be described.

### First Application Example

The inspection device 1 is applied to distinguish a bubble and a foreign matter on a rubber plug of a syringe to reduce erroneous detections. Specifically, the inspection device 1 detects and labels all items captured on the rubber plug in the conventional inspection, and excludes what appears to be a bubble from the detected items in the AI processing.

### Second Application Example

The inspection device 1 is applied to distinguish a bubble floating in a liquid surface and a foreign matter to reduce erroneous detections. Specifically, the AI learns the degree of lowering of the liquid surface, and determines whether or not there is a foreign matter. In addition, when there is a difference in shape between a bubble and a foreign matter desired to be detected, the AI is caused to learn the difference to exclude the detection of a bubble, so that the application is achieved.

### Third Application Example

The inspection device 1 learns a water droplet present in an air layer portion of a barrel portion (shoulder portion) and distinguishes a water droplet from a scratch or a smear. Specifically, the inspection device 1 detects and labels all items captured in the air layer portion in the conventional inspection. Then, the inspection device 1 excludes what appears to be a water droplet from the detected items in the AI processing.

### Fourth Application Example

The inspection device 1 learns a water droplet present in an air layer portion of a freeze-dried formulation and distinguishes a water droplet from a scratch or a smear. Specifically, the inspection device 1 detects and labels all items captured in the air layer portion in the conventional inspection. Then, the inspection device 1 excludes what appears to be a water droplet from the detected items in the AI processing, so that the application is achieved.

### Fifth Application Example

The inspection device 1 learns a water droplet attached to an inner side of a rubber plug of a vial and distinguishes a water droplet from a smear or a foreign matter. Specifically, the inspection device 1 detects and labels all items captured on the rubber plug in the conventional inspection. Then, to distinguish a water droplet from a smear or a foreign matter, the inspection device 1 excludes the shade of the rubber plug and what appears to be a water droplet from the detected items in the AI processing, so that the application is achieved.

### Modifications

The present invention is not limited to the above-described embodiments, and encompasses various modifications. For example, the above-described embodiments have been described in detail to describe the present invention in an easily understandable manner, and the present invention is not necessarily limited to those including all the configurations described above. It is possible to replace part of the configuration of a certain embodiment with the configuration of another embodiment, and it is also possible to add the configuration of a certain embodiment to the configuration of another embodiment. In addition, it is also possible to add, remove, or replace another configuration with respect to the configuration of each embodiment.

Each of the configurations, functions, processors, processing units, and the like described above may be partially or entirely achieved with hardware such as an integrated circuit, for example. Each of the configurations, functions, and the like may be achieved in software by a processor interpreting and executing programs which achieve the respective functions. Information such as programs, tables, and files for achieving the respective functions may be placed in a storage device such as a memory, a hard disk, or an SSD (Solid State Drive) or a storage medium such as a flash memory card or a DVD (Digital Versatile Disk).

In each embodiment, as control lines and information line, those that are necessary for description are shown, and it cannot necessarily be said that all the control lines and the information lines are shown in terms of products. In practice, it is also possible to consider that almost all configurations are connected to one another.

Modifications of the present invention include the following (a) to (d), for example.
(a) The present invention may be applied to not only appearance inspections but also in-liquid inspections.
(b) The inspection target object of the present invention is not limited to a vial and a freeze-dried formulation but may be containers such as ampoules and any other objects.
(c) The present invention is not limited to a transparent container.
(d) The labeling method in the present invention is not limited as long as the method can apply label information indicating a desired region of foreign matter in an image through machine learning.

### REFERENCE SIGNS LIST

1 inspection device
2 camera
3 image processing unit (image processor)
4 AI processing unit (AI processor)
31 inspection processor
41 learning parameter
5 learning environment device
51 learning parameter
52 learning unit
53 performance checking unit
6 storage device
7 determination unit
8 inspection target container

1. An inspection device comprising:
an image processor which conducts image processing on a video image captured of an inspection target object;
an Al processor which labels a foreign matter captured in the video image of the inspection target object based on a learning parameter obtained by learning teaching data in which a video image of the inspection target object and an indicator indicating whether the inspection target object is a non-defective item or a defective item are combined; and
a determination unit which determines whether the inspection target object is a non-defective item or a defective item based on a video image processed by the image processor and a video image labeled by the Al processor.

2. The inspection device according to claim 1, wherein the determination unit extracts a first abnormal region from the video image processed by the image processor and extracts a second abnormal region from the video image labeled by the Al processor.

3. The inspection device according to claim 2, wherein the determination unit determines whether the inspection target object is a non-defective item or a defective item through a logical conjunction between the first abnormal region and the second abnormal region.

4. The inspection device according to claim 2, wherein the determination unit determines whether the inspection target object is a non-defective item or a defective item through a logical disjunction between the first abnormal region and the second abnormal region.

5. The inspection device according to claim 2, wherein the determination unit determines whether the inspection target object is a non-defective item or a defective item by using a result of synthesizing one having a first predetermined size among the first abnormal regions and one having a second predetermined size among the second abnormal regions.

6. An inspection method comprising the steps of:
conducting image processing on a video image captured of an inspection target object, by an image processor;
labeling a foreign matter captured in the video image of the inspection target object based on a learning parameter obtained by learning teaching data in which a video image of the inspection target object and an indicator indicating whether the inspection target object is a non-defective item or a defective item, by a Al processor; and
determining whether the inspection target object is a non-defective item or a defective item based on a video image processed by the image processor and a video image labeled by the Al processor, by a determination unit.
